(19) United States
(12) Patent Application Publication
(10) Pub. No.: US 2006/0132400 A1
(43) Pub. Date: Jun. 22, 2006

(54) Ambient light detection using an OLED device

(75) Inventors: Ronald S. Cok, Rochester, NY (US); Felipe A. Leon, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/017,279

(22) Filed: Dec. 20, 2004

(51) Int. Cl. G09G 3/30

(52) U.S. Cl. 345/81

(57) ABSTRACT

An OLED device for the detection of ambient light level, comprising: a) a substrate; b) one or more OLED element(s) formed on the substrate and having a common electrical connection for passing current through the OLED element(s); c) one or more transistor circuit(s) for controlling current passing through the OLED element(s); and d) a controller for measuring a current passing through the common electrical connection when the OLED element(s) and/or transistor circuit(s) are exposed to ambient light, for controlling the transistor circuit(s), and for comparing the current measured to an established current response under pre-determined ambient and OLED conditions to determine ambient light level.

### FIELD OF THE INVENTION

The present invention relates to solid-state flat-panel OLED devices, and more particularly to such display devices for sensing ambient illumination.

### BACKGROUND OF THE INVENTION

Solid-state organic light emitting diode (OLED) image display devices are of great interest as a superior flat-panel digital display device and in solid-state lighting applications. These OLED devices utilize current passing through thin films of organic material to generate light. The color of light emitted and the efficiency of the energy conversion from current to light are determined by the composition of the organic thin-film material.

When viewed in a dark environment (little ambient radiation), a display or lamp need not be as bright as when viewed in a brighter environment (more ambient radiation). If the OLED device light output is recalibrated periodically, it can compensate for the ambient light to provide a preferred brightness. This can, in turn, increase OLED device lifetime by reducing unnecessary brightness in a dark environment and increase OLED device visibility in a bright environment. Alternatively, an OLED lamp may be brighter in the dark and less bright in bright ambient conditions so as to maintain the environment at a constant lightness.

The use of photosensors with displays to detect ambient light and adjusting the brightness of the display in response to ambient illumination is known. For example, see JP 2002-297096-A, which describes a circuit for providing ambient compensation to an electro-luminescent display. However, as implemented, the sensor is separate from the display and senses the light at a single point. This increases the cost, number of components, and size of the device, reduces the sensitivity of the sensor, and does not directly measure the light incident on the display itself.

It is possible to integrate photo-sensors into a display device. U.S. Pat. No. 6,717,560 entitled “Self-illuminating imaging device” by Cok et al issued 20040406 describes a self-illuminating solid-state color image capture device, includes: an array of light emitting elements and light sensing elements formed on a common substrate; the light emitting elements including first color elements adapted to emit light of a first color and second color elements adapted to emit light of a second color, and the light sensing elements being responsive to all emitted colors; and electronics coupled to the light emitting and light sensing elements for sequentially causing the first and second color elements to emit light and sensing the light reflected from a scene being captured with the light sensing elements. However, this approach requires the use of valuable substrate space for the integration of sensors and supporting circuitry.

It is known to integrate a light sensor on a display device for the purpose of sensing light emitted from the display device itself. See for example, U.S. Pat. No. 6,489,631 issued Dec. 3, 2002 to Young et al., which describes a display having integrated photosensors for sensing light emitted by a light-emitting element of the display. However, the arrangement of the sensor coupled with a light emitter limits the size of the photosensor and its ability to sense ambient light. Moreover, additional circuitry in the display is required. US Patent 20030076295 entitled “Input device and input and output device” published 20030424 describes a photo-sensor integrated into a display pixel control circuit for sensing the light output from the display. However, such circuits are not well adapted to detecting ambient light.

There is a need therefore for an improved OLED device and method for the detection of ambient light within an OLED display.

### SUMMARY OF THE INVENTION

In accordance with one embodiment, the present invention is directed towards an OLED device for the detection of ambient light level, comprising: a) a substrate; b) one or more OLED element(s) formed on the substrate and having a common electrical connection for passing current through the OLED element(s); c) one or more transistor circuit(s) for controlling current passing through the OLED element(s); and d) a controller for measuring a current passing through the common electrical connection when the OLED element(s) and/or transistor circuit(s) are exposed to ambient light, for controlling the transistor circuit(s), and for comparing the current measured to an established current response under predetermined ambient and OLED conditions to determine ambient light level.

In accordance with another embodiment, the present invention is directed towards a method for the detection of ambient light, comprising: a) providing an OLED device by forming one or more OLED element(s) on a substrate and one or more transistor circuit(s) for controlling current passing through the OLED element(s), the OLED element(s) having a common electrical connection for passing current through the OLED element(s); b) providing a controller for measuring the current passing through the common electrical connection and for controlling the transistor circuit(s); c) exposing the OLED element(s) and/or transistor circuit(s) of the OLED device to ambient light, driving the OLED element(s) with a known drive signal, and measuring a current passing through the common electrical connection; and d) comparing the measured current to an established OLED device current response determined under known ambient and OLED conditions to determine the amount of ambient light incident on the OLED element(s).

### ADVANTAGES

The advantages of this invention are an OLED device with improved ambient illumination detection and simplified construction.

### BRIEF DESCRIPTION OF THE DRAWINGS

FIG. 1 is a schematic diagram of one embodiment of the present invention;

FIG. 2 is a more detailed schematic diagram of an embodiment of the present invention; and

FIG. 3 is a further detailed schematic diagram of an embodiment of the present invention; and

FIG. 4 is a graph illustrating the current response of an OLED device to a given drive signal in the presence of varying ambient illumination.

### DETAILED DESCRIPTION OF THE INVENTION

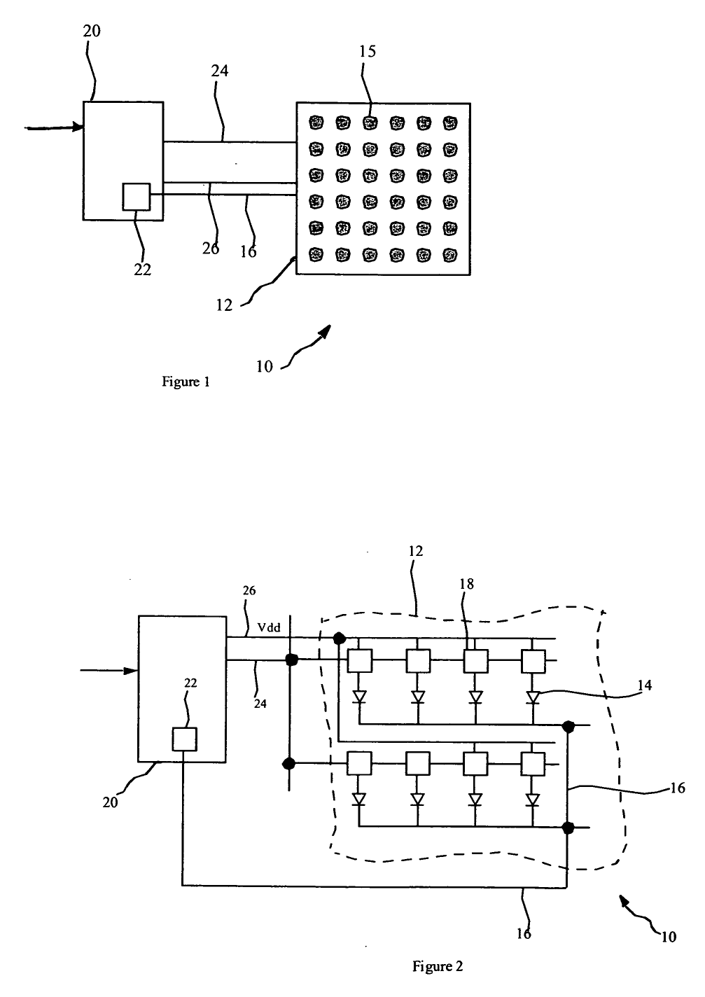

Referring to FIGS. 1, 2 and 3, one embodiment of an OLED device 10 for the detection of ambient light level, comprises a substrate 12; one or more OLED element(s) 14 formed on the substrate 12 and having a common electrical connection 16 (and/or 26) for passing current through the OLED element(s) 14; one or more transistor circuit(s) 18 for controlling current passing through the OLED element(s) 14; a controller 20 for measuring a current passing through the common electrical connection when the OLED element(s) 14 and/or transistor circuit(s) 18 are exposed to ambient light, for controlling the transistor circuit(s) 18, and for comparing the current measured to an established current response under pre-determined ambient and OLED conditions to determine ambient light level.

The OLED device 10 may have one or more OLED elements 14 and the transistor circuit 18 may be integrated on the substrate 12 locally to an OLED element 14 to form a pixel 15 of an active-matrix OLED device. In this case, a plurality of pixels 15 may be distributed regularly over the surface of the substrate 12 as shown in FIG. 1 and may be employed in a display. Alternatively, while not shown, the transistor circuit(s) 18 may be integrated on the substrate 12 at the periphery of the OLED substrate 12 or externally to the substrate 12 in a passive-matrix configuration. Such a configuration is useful for displays and also for area illumination, for example in lamps.

FIG. 2 illustrates a plurality of transistor circuits 18 distributed over a portion of the substrate 12 for driving associated OLED element(s) 14 and connected to the controller 20 through control signals 24. An electrical connection for power signal 26 (Vdd) may be provided in common to every pixel 15 together with an electrical connection 16 for a ground or cathode voltage signal CV likewise connected in common to every pixel 15. The current passing through the common electrical connection 16 (or the power signal 26) may be measured by a current measuring device 22. The transistor circuits 18, OLED elements 14, controller 20, electrical connections 26 and 16, and a current measuring device 22 are all well known in the prior art.

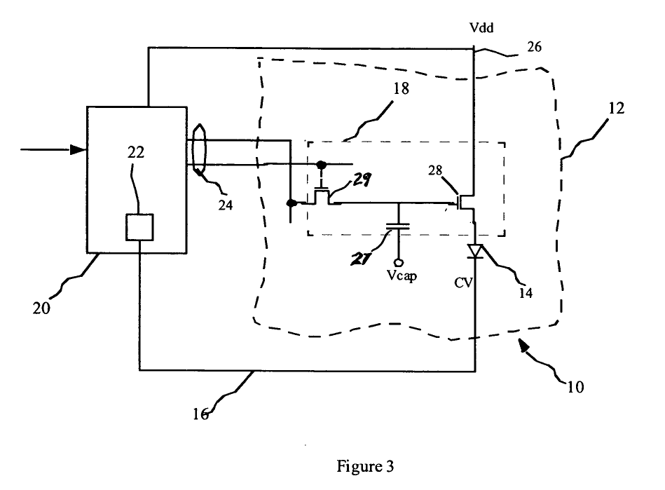

FIG. 3 illustrates one of the one or more transistor circuits 18 for driving the OLED element(s) 14 and connected to the controller 20 through control signals 24 and power signals 16 and 26. As shown in FIG. 3, control signals 24 comprising data and select signals deposit charge on a capacitor 27 through a control transistor 29. The capacitor 27 is also connected to a driving transistor 28. The amount of charge deposited on the capacitor 27 controls the amount of current passing through the drive transistor 28 and the amount of light emitted from the OLED element 14. The transistor circuits 18 and its constituent components are all well known in the prior art.

Silicon transistors and circuit elements are known to change their behavior when exposed to light. Likewise, the behavior of an OLED element changes when exposed to light, although much less significantly. Applicants have determined that, when the transistor circuit(s) 18 and OLED element(s) 14 are exposed to light, a consistent, proportional and measurable change in current passing through the OLED results and may be measured through a common electrical connection to the OLED element(s), for example power signal 26 or signal 16. Silicon devices including polysilicon, amorphous silicon, continuous grain silicon, micro-crystalline silicon, or crystalline silicon circuits may respond in this way. Thin-film devices are known and may be employed for transistor circuit 18.

In a particular embodiment, the OLED device may comprise a display device, and the plurality of OLED elements 14 may define or be part of a display area. The present invention has the great advantage of not requiring any additional circuitry on the substrate 12 and of integrating the response due to ambient light over the entire display area. The common electrical connections of the present invention may be the CV ground signal 16 typically connected to the cathode of the OLED element(s), or Vdd signal 26 that provides power to the OLED element(s) through drive transistor 28. Although signal 26 is not directly connected to OLED element(s) 14, it is considered a common electrical connection for the OLED element(s) 14 according to the present invention as it supplies power to all of the OLED elements in common. All these electrical connections are present in conventional OLED devices. The only additional circuitry required is a measurement circuit 22 for measuring the current used by the OLED element(s). Such a measurement circuit is readily integrated into a conventional controller using conventional designs and manufacturing processes known in the art. The construction of an OLED device is also known in the art. The present invention may be applied to a variety of transistor circuit designs, including both constant current source and constant voltage source transistor circuits.

According to the present invention, a method for the detection of ambient light may include the steps of providing an OLED device 10 by forming one or more OLED element(s) 14 on a substrate 12 and one or more transistor circuit(s) 18 for controlling current passing through the OLED element(s) 14, the OLED element(s) 14 having a common electrical connection 16 (and/or 26) for passing current through the OLED element(s) 14; providing a controller 20 for measuring the current passing through the common electrical connection and for controlling the transistor circuit(s) 18; exposing the OLED element(s) 14 and/or transistor circuit(s) 18 of the OLED device 10 to ambient light, driving the OLED element(s) 14 with a known drive signal, and measuring a current passing through the common electrical connection; and comparing the measured current to an established OLED device current response determined under known ambient and OLED conditions to determine the amount of ambient light incident on the OLED element(s) 14.

To accomplish this, the OLED device 10 may be first calibrated to establish an OLED device current response by operating the device in a controlled environment under known ambient and OLED conditions with a predetermined known test signal. The OLED device 10 will output light in accordance with the known test signal and will consume a first amount of current. The OLED device 10 is then used for an application in an environment with unknown ambient light surround. The OLED device 10 is operated with the known test signal and a second current measured. This second current will be different from the first current because of the effect of incident ambient radiation on the OLED element(s) 14 and transistor circuit(s) 18. The first and second currents are compared to determine the intensity of the ambient light incident on the OLED device 10. The current measured by the current measuring device 22 will include all of the current from all of the OLED element(s) having a common electrical connection 16. Typically, all of the OLED elements on the OLED device are connected in common, thereby providing a great deal of current and a sensitive means to detect incident ambient illumination.

As shown in FIG. 3; the common electrical connection 16 is labeled CV and connected directly to the OLED element cathode. However, other arrangements are possible, for example the common electrical connection could be the Vdd signal 26 used to provide power to the driving transistor 28 of the transistor circuit 18 and is not directly connected to the OLED element itself. As discussed above and used herein, a common electrical signal may refer to a single electrical signal that carries the current used to drive the OLED element(s) and is connected to either the transistor circuit 18 or OLED element 14. A variety of transistor circuits are known in the art, including, for example, constant current circuits, circuits designed to reduce dependence on transistor variability, time-based control, and circuits utilizing photo-sensitive elements to compensate for variability in OLED output.

Although the current measurement used to determine ambient illumination must be made with a known drive signal, the signal may be very short and may not be noticeable to a user. For example, a single frame of a video signal (1/30 or 1/60 seconds) may be employed. Moreover, the known signal may be dark and gray so as to be as unobtrusive as possible. The signal may be a flat-field or may be colored. The signal may be a part of a user interface, for example a start-up screen, or may have icons that represent marketing information such as advertisements or corporate logos. Alternatively, if the overall characteristics of a drive signal over time are known (but a specific, instantaneous signal is unknown) the current may be measured as an average over time for such drive signal. In this case, no special test signal need be employed. This may be effective if the OLED device is employed to view video sequences. The average color and brightness of a video or sequence of still images is typically an 18% gray. If it is known that the drive signal is a video or still image sequence, such known average brightness and content (over time) for such signal may be used as an estimate, and a repeatable current measurement over time may be made. In yet another alternative, a specific known test signal may be employed by the device as part of its user interface, for example as part of a start-up process splash screen or logo. In these cases, no additional known test signal need be employed.

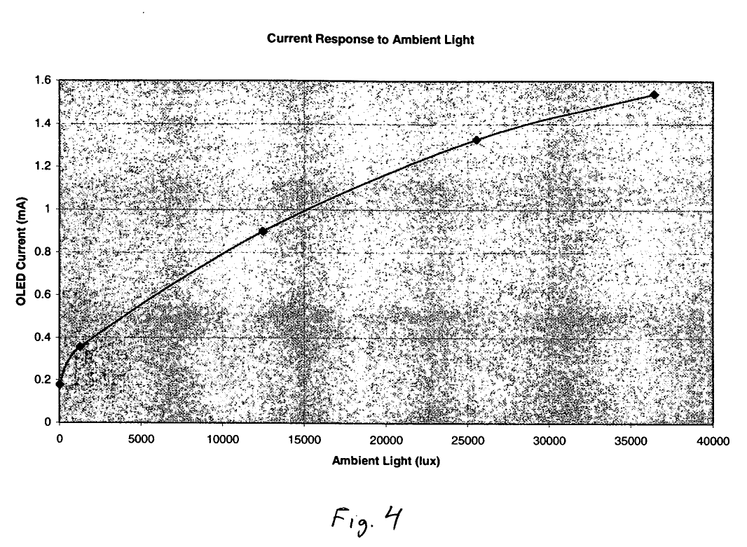

Referring to FIG. 4, the response of the OLED device to ambient light at a variety of ambient illumination intensities and with a given known test signal is shown. By comparing the magnitude of the difference between any two points on the curve, we can determine the ambient illumination incident on the OLED device. For example, if a first measurement is made in a completely dark surround, the current used by the device is slightly less than 0.2 mA. Under increased ambient illumination, the current increases, even though the drive signal is not changed. For example, as illustrated in FIG. 4, at 15,000 Lux, the OLED current has increased to 1 mA, more than a factor of 5. By measuring the current at a variety of light levels, a complete response curve such as that shown in FIG. 4 may be determined and a lookup table used to relate the current measurement to the incident ambient illumination. A current measurement made under ambient light conditions with the known test signal may then be applied to the table to determine the incident ambient illumination.

The construction of a lookup table may be performed as part of a factory calibration of an OLED device and may include determining the entire current response to incident ambient illumination curve by using multiple measurements or a single point on the curve determined and a typical curve employed to create the table. Alternatively, if the variability in OLED device performance is small enough to meet the requirements of a particular application, the established OLED device current response may be determined on a single device and the associated conversion table may be used for all subsequent similar devices. In this case, a functional transformation (possibly implemented with a lookup table) using the pre-established response may be provided in the controllers shipped with the OLED devices. Therefore, the calibration of the established OLED device current response to incident ambient illumination may be measured for each device or for an exemplary device. Complete response curves may be determined for each OLED device or family of OLED devices, or single values used and typical performance curves employed.

Applicants have also determined that the operating temperature of an OLED device can affect the current and brightness of an OLED device. To more accurately measure the incident ambient illumination, the temperature of the OLED may be measured, for example with a thermistor on the back of the OLED device, and the temperature used to correct the current curves. By simply measuring the effect of temperature on the current use of the OLED device, a family of curves at a variety of temperatures may be created and employed to measure the incident ambient illumination.

The transistor circuit can be manufactured using thin-film technology using silicon or organic semiconductors as is known in the art. The present invention may be used in both top- and bottom-emitting OLED structures. The only requirement is that the OLED element(s) and/or the transistor circuit(s) are exposed to the ambient light. This arrangement is employed today in OLED devices sold on the market (for example, the OLED display employed in the Eastman Kodak Company digital camera model LS633).

In a preferred embodiment, all of the pixels of the OLED device have a common electrical connection as described herein. In an alternative embodiment, however, it may be desirable to connect in common and employ only a sub-set of the pixels to determine ambient illumination. This may be useful, for example, if the behavior of some pixels are more responsive and predictable than others, and/or if different power or control signals or transistor circuitry are required for different pixel groups. While the invention is described above primarily in connection with OLED devices comprising a plurality of pixels, in an extreme case, an OLED device, e.g., a lamp, may comprise a single pixel, and the present invention is applicable thereto.

The measurement of ambient illumination obtained in accordance with the invention may be used to control the desired brightness of the OLED elements of the OLED device. For example, the present invention may be employed in a display system capable of maintaining constant ambient contrast ratio by controlling the brightness of ihe display in response to the measured brightness of the ambient surround. For example, in a dark surround, where the measurement of ambient brightness is relatively small, a display device may be controlled to be relatively dim. In contrast, if the measurement of ambient brightness is relatively large, a display device may be controlled to be relatively bright, thereby enhancing the readability of the display device in bright conditions and conserving power in dim conditions. If applied in an illumination system, if the measurement of ambient brightness is relatively small, a lamp may be controlled to be brighter, and if the measurement of ambient brightness is relatively large, a lamp may be controlled to be relatively dimmer, so that the light in a local environment may be maintained relatively constant.

In a preferred embodiment, the invention is employed in a device that includes Organic Light Emitting Diodes (OLEDs) which are composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light emitting displays can be used to fabricate such a device.

The invention has been described in detail with particular reference to certain preferred embodiments thereof, but it will be understood that variations and modifications can be effected within the spirit and scope of the invention.

### PARTS LIST

10 OLED device
12 substrate
14 OLED element
15 pixel
16 electrical connection
18 transistor circuit
20 controller
22 current measuring device
24 signal line(s)
26 electrical connection
27 capacitor
28 drive transistor
29 control transistor

1. An OLED device for the detection of ambient light level, comprising:
a) a substrate;
b) one or more OLED element(s) formed on the substrate and having a common electrical connection for passing current through the OLED element(s);
c) one or more transistor circuit(s) for controlling current passing through the OLED element(s); and
d) a controller for measuring a current passing through the common electrical connection when the OLED element(s) and/or transistor circuit(s) are exposed to ambient light, for controlling the transistor circuit(s), and for comparing the current measured to an established current response under pre-determined ambient and OLED conditions to determine ambient light level.

2. The OLED device claimed in claim 1, wherein the transistor circuit(s) are formed on the substrate.

3. The OLED device claimed in claim 2, wherein the OLED device is an active-matrix OLED device.

4. The OLED device claimed in claim 1, wherein the OLED device is a passive-matrix device.

5. The OLED device claimed in claim 1, further comprising a temperature sensor for measuring the temperature of the OLED device, and wherein the temperature measurement is used together with the current measurements to determine the level of ambient light.

6. The OLED device claimed in claim 1, wherein the OLED device is a lamp.

7. The OLED device claimed in claim 1, wherein the OLED device is a display.

8. The OLED device claimed in claim 1, wherein the transistor circuits are thin-film circuits.

9. The OLED device claimed in claim 1, wherein the transistor circuits are silicon circuits.

10. A method for the detection of ambient light, comprising:
a) providing an OLED device by forming one or more OLED element(s) on a substrate and one or more transistor circuit(s) for controlling current passing through the OLED element(s), the OLED element(s) having a common electrical connection for passing current through the OLED element(s);
b) providing a controller for measuring the current passing through the common electrical connection and for controlling the transistor circuit(s);
c) exposing the OLED element(s) and/or transistor circuit(s) of the OLED device to ambient light, driving the OLED element(s) with a known drive signal, and measuring a current passing through the common electrical connection; and
d) comparing the measured current to an established OLED device current response determined under known ambient and OLED conditions to determine the amount of ambient light incident on the OLED element(s).

11. The method of claim 10, wherein the established OLED device current response is determined by exposing the OLED element(s) and/or transistor circuit(s) of the OLED device to a known amount of incident light, driving the OLED element(s) with a known signal, and measuring the current passing through the common electrical connection of the OLED device.

12. The method of claim 10, wherein the established OLED device current response is determined by exposing a separate OLED device having one or more OLED element(s) having a common electrical connection and one or more transistor circuits for driving the OLED element(s) to a known amount of incident light, driving the OLED element(s) of the separate OLED device with a known signal, and measuring the current passing through the common electrical connection of the separate OLED device.

13. The method claimed in claim 10, wherein the established OLED device current response is used to determine a conversion function between current and incident ambient illumination prior to shipping the OLED device to a customer.

14. The method claimed in claim 13, wherein the conversion function is implemented as a lookup table.

15. The method claimed in claim 13, wherein the conversion function is incorporated into the controller and employed to convert measured currents to incident ambient illumination.

16. The method claimed in claim 10, wherein the drive signal in step c) is a gray flat-field signal, a colored flat-field signal, a graphic user interface signal, or iconic display signal.

17. The method claimed in claim 10, wherein the current measured in step c) is an average measured current over a period of time.

18. The method claimed in claim 10, further comprising measuring the temperature of the OLED device with a temperature sensor.

19. The method claimed in claim 18, wherein the temperature measurement is used together with the current measurement to determine the level of ambient light.

20. The method of claim 10, further comprising controlling the desired brightness of the OLED element(s) of the OLED device in response to the determined amount of ambient light incident on the OLED element(s).
